(19) United States
(12) Patent Application Publication
(10) Pub. No.: US 2025/0056640 A1
(43) Pub. Date: Feb. 13, 2025

(54) METHOD AND APPARATUS FOR TRANSMITTING RADIO RESOURCE CONTROL (RRC) REJECT MESSAGE

(71) Applicant: Beijing Xiaomi Mobile Software Co., Ltd., Beijing (CN)

(72) Inventors: Rao SHI, Beijing (CN); Yumin WU, Beijing (CN)

(21) Appl. No.: 18/710,576

(22) PCT Filed: Nov. 17, 2021
(86) PCT No.: PCT/CN2021/131321

§ 371 Date: May 15, 2024

(51) Int. Cl. H04W 76/18; H04W 74/0833

(52) U.S. Cl. CPC H04W 76/18; H04W 74/0833

(57) ABSTRACT

In a method for transmitting a radio resource control (RRC) reject message, a radio resource control (RRC) resume request message sent from a terminal device is received, target indication information is obtained from a second network device in response to rejecting access of the terminal device, and the RRC reject message is sent to the terminal device according to the target indication information.

### BACKGROUND OF THE INVENTION

In a 5G new radio (NR) system, when a terminal attempts to resume a radio resource control (RRC) connection, a network side can send an RRC reject message through a common control channel (CCCH) to reject the access of the terminal.

### SUMMARY OF THE INVENTION

The disclosure relates to the technical field of communication, in particular to a method and apparatus for transmitting a radio resource control (RRC) reject message.

A first aspect example of the disclosure provides a method for transmitting a radio resource control (RRC) reject message. The method is performed by a first network device, and includes:
receiving a radio resource control (RRC) resume request message sent from a terminal device;
obtaining target indication information from a second network device in response to rejecting access of the terminal device; and
sending the radio resource control (RRC) reject message to the terminal device according to the target indication information.

A second aspect example of the disclosure provides a method for transmitting a radio resource control (RRC) reject message. The method is performed by a second network device, and includes:
sending target indication information to a first network device in response to determining that the first network device rejects access of a terminal device, where the target indication information is configured to send the radio resource control (RRC) reject message to the terminal device.

A third aspect example of the disclosure provides a method for transmitting a radio resource control (RRC) reject message. The method is performed by a terminal device, and includes:
sending a radio resource control (RRC) resume request message to a first network device; and
receiving an RRC reject message sent from the first network device, where the RRC reject message carries a reject message authentication code for integrity (RejectMAC-I).

A fourth aspect example of the disclosure provides a communication apparatus. The apparatus includes a processor and a memory, where the memory stores a computer program, and the processor executes the computer program stored in the memory, so as to cause the apparatus to perform the method for transmitting a radio resource control (RRC) reject message according to the first aspect example, or perform the method for transmitting a radio resource control (RRC) reject message according to the second aspect example.

A fifth aspect example of the disclosure provides a communication apparatus. The apparatus includes a processor and a memory, where the memory stores a computer program, and the processor executes the computer program stored in the memory, so as to cause the apparatus to perform the method for transmitting a radio resource control (RRC) reject message according to the third aspect example.

A sixth aspect example of the disclosure provides a communication apparatus. The apparatus includes a processor and an interface circuit, where the interface circuit is configured to receive a code instruction and transmit the code instruction to the processor, and the processor is configured to run the code instruction, so as to perform the method for transmitting a radio resource control (RRC) reject message according to the first aspect example, or perform the method for transmitting a radio resource control (RRC) reject message according to the second aspect example.

A seventh aspect example of the disclosure provides a communication apparatus. The apparatus includes a processor and an interface circuit, where the interface circuit is configured to receive a code instruction and transmit the code instruction to the processor, and the processor is configured to run the code instruction, so as to perform the method for transmitting a radio resource control (RRC) reject message according to the third aspect example.

An eighth aspect example of the disclosure provides a non-transitory computer-readable storage medium, configured to store an instruction. The instruction causes the method for transmitting a radio resource control (RRC) reject message according to the first aspect example or the method for transmitting a radio resource control (RRC) reject message according to the second aspect example to be implemented when performed.

A ninth aspect example of the disclosure provides a non-transitory computer-readable storage medium, configured to store an instruction. The instruction causes the method for transmitting a radio resource control (RRC) reject message according to the third aspect example to be implemented when performed.

A tenth aspect example of the disclosure provides a computer program. The computer program causes a computer to perform the method for transmitting a radio resource control (RRC) reject message according to the first aspect example or the method for transmitting a radio resource control (RRC) reject message according to the second aspect example when running on the computer.

An eleventh aspect example of the disclosure provides a computer program. The computer program causes a computer to perform the method for transmitting a radio resource control (RRC) reject message according to the third aspect example when running on the computer.

Additional aspects and advantages of the disclosure will partially be set forth in the following description, will partially become apparent from the following description, or will be learned by practice of the disclosure.

### BRIEF DESCRIPTION OF DRAWINGS

In order to more clearly illustrate the examples of the disclosure or the technical solution in the related art, an explanation to the accompanying drawings needed for the examples of the disclosure or the related art will be provided below.

FIG. 1 is a schematic diagram of an architecture of a communication system according to an example of the disclosure;

FIG. 2 is a flowchart of a method for transmitting a radio resource control (RRC) reject message according to an example of the disclosure;

FIG. 3 is a flowchart of a method for transmitting a radio resource control (RRC) reject message according to an example of the disclosure;

FIG. 4 is a flowchart of a method for transmitting a radio resource control (RRC) reject message according to an example of the disclosure;

FIG. 5 is a flowchart of a method for transmitting a radio resource control (RRC) reject message according to an example of the disclosure;

FIG. 6 is a flowchart of a method for transmitting a radio resource control (RRC) reject message according to an example of the disclosure;

FIG. 7 is a flowchart of a method for transmitting a radio resource control (RRC) reject message according to an example of the disclosure;

FIG. 8 is a flowchart of a method for transmitting a radio resource control (RRC) reject message according to an example of the disclosure;

FIG. 9 is a flowchart of a method for transmitting a radio resource control (RRC) reject message according to an example of the disclosure;

FIG. 10 is a schematic structural diagram of an apparatus for transmitting a radio resource control (RRC) reject message according to an example of the disclosure;

FIG. 11 is a schematic structural diagram of an apparatus for transmitting a radio resource control (RRC) reject message according to an example of the disclosure;

FIG. 12 is a schematic structural diagram of an apparatus for transmitting a radio resource control (RRC) reject message according to an example of the disclosure;

FIG. 13 is a schematic structural diagram of another apparatus for transmitting a radio resource control (RRC) reject message according to an example of the disclosure; and

FIG. 14 is a schematic structural diagram of a chip according to an example of the disclosure.

### DETAILED DESCRIPTION OF THE INVENTION

Description will be made in detail to illustrative examples here, instances of which are illustrated in the accompanying drawings. When the following description relates to the accompanying drawings, the same numbers in different accompanying drawings refer to the same or similar elements unless otherwise indicated. The embodiments described in the following illustrative examples do not represent all embodiments consistent with the disclosure. Rather, they are merely instances of apparatus and methods consistent with some aspects of the examples of the disclosure as detailed in the appended claims.

The terms used in the examples of the disclosure are for the purpose of describing particular examples merely and are not intended to limit the examples of the disclosure. As used in the examples and the appended claims of the disclosure, singular forms “a”, “an” and “the” are intended to include plural forms as well, unless otherwise clearly indicated in the context. It should be understood that the term “and/or” as used here refers to and encompasses any or all possible combinations of one or more of associated listed items.

It should be understood that although the terms of first, second, third, etc. may be employed in the examples of the disclosure to describe various information, such information should not be limited to these terms. These terms are merely used to distinguish the same type of information from each other. For example, first information may also be referred to as second information, and similarly, second information may also be referred to as first information, without departing from the scope of the examples of the disclosure. The word “if” as used here may be construed to mean “at the time of” or “when” or “in response to determining”, depending on the context.

Examples of the disclosure are described in detail below, and instances of the examples are illustrated in the drawings, in which same or similar reference numerals refer to the same or similar elements. The examples described below by reference to the drawings are illustrative for explaining the disclosure and are not to be construed as limiting the disclosure.

In order to better understand a method for transmitting a radio resource control (RRC) reject message disclosed in the example of the disclosure, a communication system to which the example of the disclosure is applicable is first described below.

With reference to FIG. 1, FIG. 1 is a schematic diagram of an architecture of a communication system according to an example of the disclosure. The communication system may include, but is not limited to, one first network device, one second network device and one terminal device. The number and form of devices shown in FIG. 1 are illustrative and do not constitute a limitation to the example of the disclosure, and may include two or more first network devices, two or more second network devices and two or more terminal devices in an actual application. For example, the communication system shown in FIG. 1 includes one first network device 101, one second network device 102, and one terminal device 103.

It should be noted that the technical solution of the example of the disclosure can be applied to various communication systems, for example, a long term evolution (LTE) system, a fifth generation mobile communication system, a 5G new radio system, or other future new mobile communication systems, etc.

The first network device 101 and the second network device 102 in the example of the disclosure are entities on a network side for sending or receiving signals. For example, the first network device 101 and the second network device 102 may be evolved NodeBs (eNBs), transmission reception points (TRPs), next generation NodeBs (gNBs) in an NR system, base stations in other future mobile communication systems, or access nodes in a wireless fidelity (WiFi) system, etc. The example of the disclosure does not limit a particular technology and a particular device configuration used by the network devices. The network device provided in the example of the disclosure may be composed of a central unit (CU) and a distributed unit (DU). The CU may also be referred to as a control unit. By using a CU-DU structure, protocol layers of the network device, such as a base station, may be split, functions of some protocol layers are centralized controlled by the CU, and functions of some or all of the remaining protocol layers are distributed in the DU, and the DU is centralized controlled by the CU.

The terminal device 103 in the example of the disclosure is an entity on a user side configured to receive or send signals, such as a mobile phone. The terminal device may also be referred to as a terminal, user equipment (UE), a mobile station (MS), a mobile device (MT), etc. The terminal device may be a car with a communication function, a smart car, a mobile phone, a wearable device, a Pad, a computer with a radio transceiver function, a virtual reality (VR) terminal device, an augmented reality (AR) terminal device, a radio terminal device in industrial control, a radio terminal device in self-driving, a radio terminal device in remote medical surgery, a radio terminal device in a smart grid, a radio terminal device in transportation safety, a radio terminal device in a smart city, a radio terminal device in smart home, etc. The example of the disclosure does not limit a particular technology and a particular device configuration used by the terminal device.

In a 5G NR system, a terminal in an inactive state (RRC_INACTIVE) can move through the entire radio access network notification area (RNA) and can send an RRC resume request to any base station in the RNA. The base station may store a context of the terminal in an inactive state. It can be understood that the base station storing the context of the terminal is a base station of a last serving cell where the terminal is located, that is, a base station at an anchor, which may also be referred to as an old base station. In a case that the terminal moves, an RRC resume request is sent to another base station. The another base station does not store the context of the terminal. The another base station is a base station at a non-anchor, and may also be called a new base station.

When the terminal attempts RRC connection resuming, the network side may send an RRC reject message through a common control channel to reject access of the terminal, for example, to reject the access of the terminal when network congestion occurs. However, the RRC reject message is not secured and is vulnerable to attack, and a reject waitTime information element (IE) in the RRC reject message may be tampered with arbitrarily to cause the terminal to suffer a Dos attack, such that the terminal cannot enter a connection state to receive and send services.

In view of this, in order to protect the RRC reject message, a mechanism similar to a resume message authentication code for integrity (Resume MAC-I) of an RRC resume request may be used to introduce a reject message authentication code for integrity (RejectMAC-I) into the RRC reject message to protect the RRC reject message.

In the related art, calculation and generation of the reject message authentication code for integrity (RejectMAC-I) need parameter information in the context of the terminal, but the network device at a non-anchor may directly reject the access of a terminal device according to its own congestion control, and does not need to extract the context of the terminal device from a network device at the anchor.

As shown in FIG. 1, the terminal device 103 sends the RRC resume request 110 to the first network device 101. The first network device 101 rejects the access of the terminal device 103 according to its own situation, and directly sends an RRC reject message 120 to the terminal device 103 without extracting the context of the terminal device 103 from the second network device 102.

For reference, the terminal device 103 sends an RRC resume request 130 to the first network device 101. The first network device 101 allows access of the terminal device 103 according to its own situation, and the first network device 101 sends a retrieve UE context request 140 to the second network device 102. The second network device 102 returns a retrieve UE context response 150 to the first network device 101, and forwards the context of the terminal device 103. The first network device 101 establishes an RRC connection to the terminal device 103 according to the context, and sends RRC resume 160 to the terminal device 103.

In this way, the network device at an anchor stores the context of the terminal device, such that the network device at an anchor (that is, the second network device 102) can use the RejectMAC-I when rejecting the access of the terminal device 103, and the network device at a non-anchor (that is, the first network device 101) cannot calculate the RejectMAC-I because it does not have the context of the terminal device 103.

Furthermore, in a case that the RejectMAC-I is an optional function in the entire RNA, it means that the terminal device may also determine that the RRC reject message is valid even if no RejectMAC-I is received, so as to receive the RRC reject message attacked and tampered with. Therefore, this problem should also be avoided.

In the examples of the disclosure, the radio resource control (RRC) resume request message sent from the terminal device is received, the target indication information is obtained from the second network device in response to rejecting the access of the terminal device, and the radio resource control (RRC) reject message is sent to the terminal device according to the target indication information, such that the network device at a non-anchor can also send the RRC reject message that is secured. Thus security and robustness of transmitting the RRC reject message in the radio access network (RAN) are effectively improved, and the security problem caused by tampering of the RRC reject message is avoided.

It can be understood that the communication system described in the example of the disclosure is for the purpose of more clearly illustrating the technical solutions provided in the examples of the disclosure, and does not constitute a limitation on the technical solutions provided in the examples of the disclosure. Those skilled in the art will know that, along with evolution of a system architecture and emergence of new service scenes, the technical solutions provided in the examples of the disclosure are also applicable to similar technical problems.

The method and apparatus for transmitting a radio resource control (RRC) reject message provided in the disclosure are described in detail below in conjunction with the accompanying drawings.

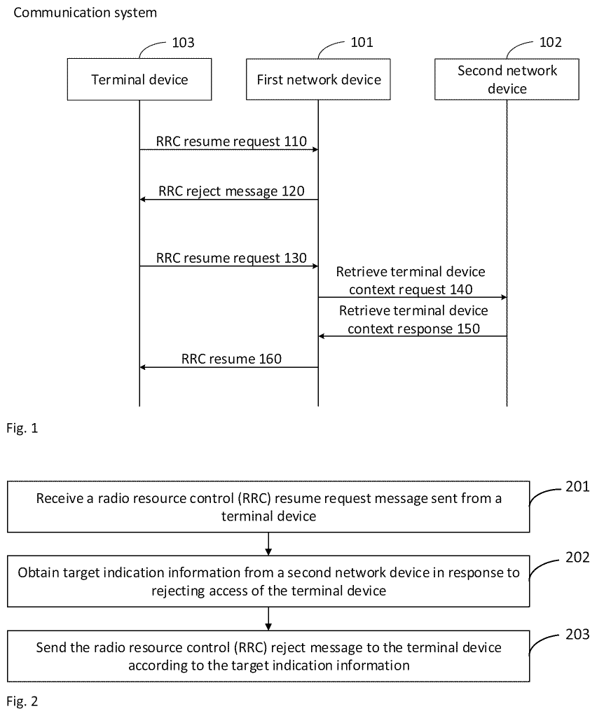

With reference to FIG. 2, FIG. 2 is a flowchart of a method for transmitting a radio resource control (RRC) reject message according to an example of the disclosure. It should be noted that the method for transmitting a radio resource control (RRC) reject message in the example of the disclosure is performed by the first network device. The first network device is a network device at a non-anchor, may also be referred to as a new network device, and means that a serving cell corresponding to the first network device is different from a last serving cell of the terminal device and is a new serving cell. It can be understood that the serving cell corresponding to the first network device and the last serving cell are located in the same radio access network notification area (RNA).

As shown in FIG. 2, the method may include following steps.

Step 201. Receive a radio resource control (RRC) resume request message sent from a terminal device.

The terminal device in an inactive state can move through the entire RNA and can send the RRC resume request to any network device in the RNA. The first network device is a network device in the RNA, and the serving cell corresponding to the first network device is different from the last serving cell of the terminal device.

The first network device may determine whether to approve the resume request of the terminal device and establish an RRC connection to the terminal device according to its own network condition, such as network congestion.

Step 202. Obtain target indication information from a second network device in response to rejecting access of the terminal device.

The second network device is a network device at an anchor, and may also be referred to as an old network device, that is, a serving cell corresponding to the second network device is the last serving cell of the terminal device.

It can be understood that the second network device has established an RRC connection to the terminal device, and context information of the terminal device is stored in both the second network device and the terminal device.

The first network device may reject the access of the terminal device according to its own network condition, such as network congestion, and obtain the target indication information from the second network device.

In some examples, the target indication information is at least one of the context of the terminal device and the reject message authentication code for integrity (RejectMAC-I).

As a first possible implementation, in response to rejecting access of the terminal device, the first network device obtains the context of the terminal device from the second network device.

As a second possible implementation, in response to rejecting the access of the terminal device, the first network device obtains the reject message authentication code for integrity (RejectMAC-I) from the second network device.

As a third possible implementation, in response to rejecting the access of the terminal device, the first network device obtains the context of the terminal device and the reject message authentication code for integrity (RejectMAC-I) from the second network device.

The reject message authentication code for integrity (RejectMAC-I) is calculated and generated through a certain algorithm according to the parameter information in the context of the terminal device. The terminal device can determine the validity of the RRC reject message according to the RejectMAC-I.

In some examples, the RejectMAC-I is calculated and generated according to the parameter information through an integrity algorithm for 5G (NIA).

In some examples, the parameter information includes at least one of: a key, a bear ID, a data transmission direction, a sequence number (COUNT value), a source cell radio network temporary identifier (source C-RNTI), a source physical cell identifier (source PCI), a target cell-ID, a resumeCause, and a waitTime.

Step 203. Send the radio resource control (RRC) reject message to the terminal device according to the target indication information.

The RRC reject message is sent to the terminal device according to the target indication information obtained from the second network device. It can be understood that the RRC reject message is an RRC reject message that is secured.

In some embodiments, the RRC reject message carries a reject message authentication code for integrity (RejectMAC-I).

As a first possible implementation, the radio resource control (RRC) reject message is sent to the terminal device according to the context of the terminal device.

Further, the first network device may extract parameter information from the context of the terminal device according to the context, generate the RejectMAC-I according to the parameter information, and send the RRC reject message carrying the RejectMAC-I to the terminal device.

It should be noted that since the RejectMAC-I is calculated and generated according to the parameter information in the context through a certain algorithm, the terminal device may calculate and generate a RejectMAC-I according to the parameter information in the context stored by the terminal device through the same algorithm. After receiving the authentication code, the terminal device may perform matching verification on the received RejectMAC-I and the RejectMAC-I calculated and generated by the terminal device, and in a case that comparison and matching succeeds, the verification passes, indicating that the RRC reject message is valid.

As a second possible implementation, the radio resource control (RRC) reject message is sent to the terminal device according to the reject message authentication code for integrity (RejectMAC-I).

Further, the first network device writes the obtained RejectMAC-I into a corresponding field in the RRC reject message, and sends the RRC reject message carrying the RejectMAC-I to the terminal device.

As a third possible implementation, the radio resource control (RRC) reject message is sent to the terminal device according to the context of the terminal device and the reject message authentication code for integrity (RejectMAC-I).

In the example of the disclosure, the first network device may further send first indication information to the terminal device. The first indication information is configured to indicate to the terminal device that the reject message authentication code for integrity (RejectMAC-I) is available in the entire RNA.

In some examples, the first indication information is a system message. That is, the first network device may indicate to the terminal device through the system message that a network supports the reject message authentication code for integrity (RejectMAC-I) in the entire RNA, and the terminal device may use the reject message authentication code for integrity (RejectMAC-I) to determine the validity of the RRC reject message.

In summary, the radio resource control (RRC) resume request message sent from the terminal device is received, the target indication information is obtained from the second network device in response to rejecting the access of the terminal device, and the radio resource control (RRC) reject message is sent to the terminal device according to the target indication information, such that the network device at a non-anchor can also send the RRC reject message that is secured. Thus security and robustness of transmitting the RRC reject message in the radio access network (RAN) are effectively improved, and the security problem caused by tampering of the RRC reject message is avoided.

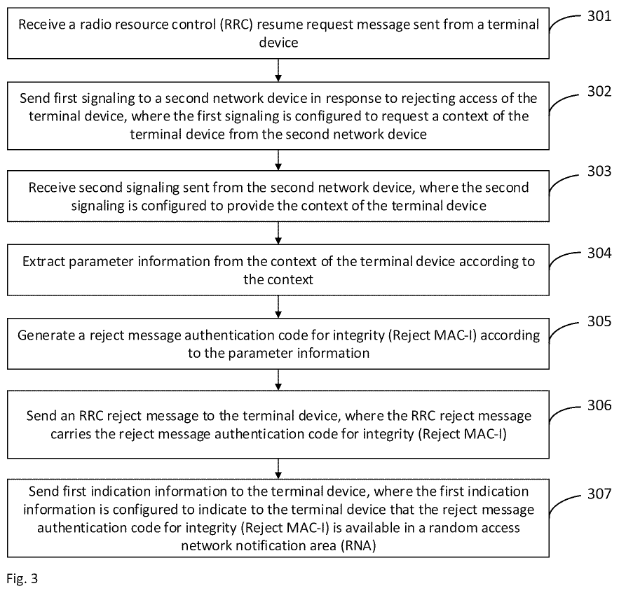

With reference to FIG. 3, FIG. 3 is a flowchart of a method for transmitting a radio resource control (RRC) reject message according to an example of the disclosure. It should be noted that the method for transmitting a radio resource control (RRC) reject message in the example of the disclosure is performed by the first network device. Relevant description about the first network device is as described above, and is not repeated here.

As shown in FIG. 3, the method may include following steps.

Step 301. Receive a radio resource control (RRC) resume request message sent from a terminal device.

In the example of the disclosure, step 301 may be implemented in any manner of the example of the disclosure, which is not limited by the example of the disclosure and will not be repeated here.

Step 302. Send first signaling to a second network device in response to rejecting access of the terminal device, where the first signaling is configured to request a context of the terminal device from the second network device.

The first network device requests the context of the terminal device from the second network device by sending the first signaling to the second network device. After receiving the first signaling, the second network device can retrieve the context of the terminal device.

In some examples, the first signaling is a retrieve UE context request, or, the first signaling is custom signaling transmitted through an Xn interface.

The first network device requests the context of the terminal device from the second network device by sending a retrieve UE context request to the second network device, or sending custom signaling transmitted through an Xn interface to the second network device.

The Xn interface is a network interface for exchanging signaling information between network devices in a radio access network (RAN).

In some examples, the custom signaling includes an identifier of the terminal device, such that the second network device can obtain the context of the corresponding terminal device after receiving the custom signaling.

Step 303. Receive second signaling sent from the second network device, where the second signaling is configured to provide the context of the terminal device.

After retrieving the context of the terminal device, the second network device forwards the context of the terminal device by returning the second signaling to the first network device.

In some examples, the second signaling is a retrieve UE context response, or, the second signaling is custom signaling transmitted through an Xn interface.

The first network device obtains the context of the terminal device by receiving the retrieve UE context response sent from the second network device, or receiving the custom signaling transmitted through the Xn interface from the second network device.

In some examples, the custom signaling includes the identifier of the terminal device, such that the first network device determines that the received context belongs to the terminal device after receiving the custom signaling.

Step 304. Extract parameter information from the context of the terminal device according to the context.

After receiving the second signaling for providing the context of the terminal device, the first network device obtains the context of the terminal device, and then extracts the parameter information from the context to calculate a reject message authentication code for integrity (RejectMAC-I).

In some embodiments, the parameter information includes at least one of: a key, a bear ID, a data transmission direction, a sequence number (COUNT value), a source cell radio network temporary identifier (source C-RNTI), a source physical cell identifier (source PCI), a target cell-ID, a resumeCause, and a waitTime.

Step 305. Generate a reject message authentication code for integrity (RejectMAC-I) according to the parameter information.

The first network device extracts the parameter information from the context, calculates and generates the reject message authentication code for integrity (RejectMAC-I) according to the parameter information through a certain algorithm.

In some embodiment, the authentication code for integrity (RejectMAC-I) is calculated and generate through the NIA according to the parameter information.

In some examples, the parameter information includes at least one of: a key, a bear ID, a data transmission direction, a sequence number (COUNT value), a source cell radio network temporary identifier (source C-RNTI), a source physical cell identifier (source PCI), a target cell-ID, a resumeCause, and a waitTime.

In some embodiments, after calculating and generating the RejectMAC-I, the first network device writes the RejectMAC-I into a preset field of the RRC reject message.

Step 306. Send an RRC reject message to the terminal device, where the RRC reject message carries the reject message authentication code for integrity (RejectMAC-I).

The first network device sends the RRC reject message to the terminal device, where the RRC reject message carries the calculated and generated reject message authentication code for integrity (RejectMAC-I).

In some embodiments, the RejectMAC-I is written in a preset field of the RRC reject message.

In the example of the disclosure, after receiving the RRC reject message carrying the RejectMAC-I, the terminal device can determine the validity of the RRC reject message according to the RejectMAC-I.

In some examples, the terminal device may calculate and generate the RejectMAC-I through the same algorithm according to the parameter information in the context stored by the terminal device. After receiving the RRC reject message carrying the RejectMAC-I, the terminal device may perform matching verification on the received RejectMAC-I and the RejectMAC-I calculated and generated by the terminal device, and in a case that comparison and matching succeeds, the verification passes, indicating that the RRC reject message is valid.

It can be understood that the terminal device is a terminal device having a determination capability.

Step 307. Send first indication information to the terminal device, where the first indication information is configured to indicate to the terminal device that the reject message authentication code for integrity (RejectMAC-I) is available in a random access network notification area (RNA).

In some examples, the first indication information is a system message.

That is, the first network device may indicate to the terminal device through the system message that a network supports the reject message authentication code for integrity (RejectMAC-I) in the entire RNA, and the terminal device may use the reject message authentication code for integrity (RejectMAC-I) to determine the validity of the RRC reject message.

In summary, the radio resource control (RRC) resume request message sent from the terminal device is received. The first signaling is sent to the second network device in response to rejecting the access of the terminal device. The first signaling is configured to request the context of the terminal device from the second network device. The second signaling sent from the second network device is received. The second signaling is configured to provide the context of the terminal device. The parameter information is extracted from the context of the terminal device according to the context. The reject message authentication code for integrity (RejectMAC-I) is generated according to the parameter information. The RRC reject message is sent to the terminal device. The RRC reject message carries the reject message authentication code for integrity (RejectMAC-I). The first indication information is sent to the terminal device. The first indication information is configured to indicate to the terminal device that the reject message authentication code for integrity (RejectMAC-I) is available in the random access network notification area (RNA). Therefore, the network device at a non-anchor can also send the RRC reject message that is secured. Thus security and robustness of transmitting the RRC reject message in the radio access network (RAN) are effectively improved, and the security problem caused by tampering of the RRC reject message is avoided.

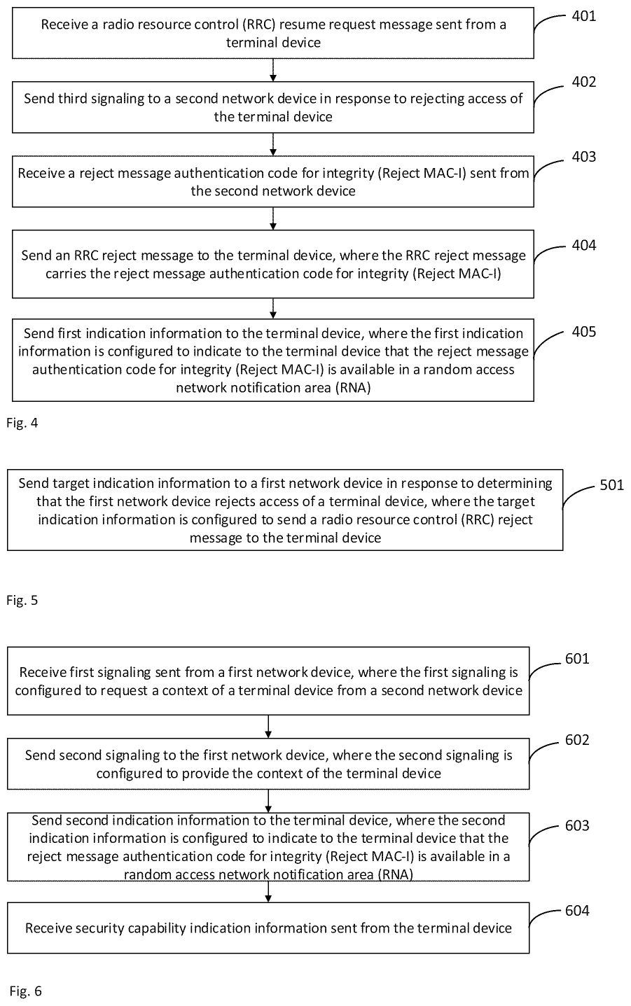

With reference to FIG. 4, FIG. 4 is a flowchart of a method for transmitting a radio resource control (RRC) reject message according to an example of the disclosure. It should be noted that the method for transmitting a radio resource control (RRC) reject message in the example of the disclosure is performed by the first network device. Relevant description about the first network device is as described above, and is not repeated here.

As shown in FIG. 4, the method may include following steps.

Step 401. Receive a radio resource control (RRC) resume request message sent from a terminal device.

In the example of the disclosure, step 401 may be implemented in any manner of the example of the disclosure, which is not limited by the example of the disclosure and will not be repeated here.

Step 402. Send third signaling to a second network device in response to rejecting access of the terminal device.

The third signaling is configured to trigger the second network device to generate the reject message authentication code for integrity (RejectMAC-I) according to the context of the terminal device.

The first network device sends the third signaling to the second network device, so as to trigger the second network device to generate the reject message authentication code for integrity (RejectMAC-I) according to the context of the terminal device.

In some embodiments, the third signaling includes the identifier of the terminal device, so as to trigger the second network device to query the context of the terminal device and generate the RejectMAC-I according to the context of the terminal device.

It can be understood that the first network device sends the third signaling to the second network device. After receiving the third signaling, the second network device queries the context of the terminal device corresponding to the third signaling, extracts the parameter information from the context, and generates the RejectMAC-I according to the parameter information.

Step 403. Receive a reject message authentication code for integrity (RejectMAC-I) sent from the second network device.

After receiving the trigger of the third signaling, the second network device queries the context of the terminal device, extracts the parameter information from the context, calculates and generates the RejectMAC-I according to the parameter information, and then sends the generated RejectMAC-I to the first network device.

In some embodiments, after receiving the RejectMAC-I, the first network device writes it into the preset field of the RRC reject message.

Step 404. Send an RRC reject message to the terminal device, where the RRC reject message carries the reject message authentication code for integrity (RejectMAC-I).

After receiving the RejectMAC-I sent from the second network device, the first network device sends the RRC reject message carrying the RejectMAC-I to the terminal device.

In some embodiments, the RejectMAC-I is written in a preset field of the RRC reject message.

In the example of the disclosure, after receiving the RRC reject message carrying the RejectMAC-I, the terminal device can determine the validity of the RRC reject message according to the RejectMAC-I.

In some examples, the terminal device may calculate and generate the RejectMAC-I through the same algorithm according to the parameter information in the context stored by the terminal device. After receiving the RRC reject message carrying the RejectMAC-I, the terminal device may perform matching verification on the received RejectMAC-I and the RejectMAC-I calculated and generated by the terminal device, and in a case that comparison and matching succeeds, the verification passes, indicating that the RRC reject message is valid.

It can be understood that the terminal device is a terminal device having a determination capability.

Step 405. Send first indication information to the terminal device, where the first indication information is configured to indicate to the terminal device that the reject message authentication code for integrity (RejectMAC-I) is available in a random access network notification area (RNA).

In the example of the disclosure, step 405 may be implemented in any manner of the example of the disclosure, which is not limited by the example of the disclosure and will not be repeated here.

In summary, the radio resource control (RRC) resume request message sent from the terminal device is received. The third signaling is sent to the second network device in response to rejecting the access of the terminal device. The reject message authentication code for integrity (RejectMAC-I) sent from the second network device is received. The RRC reject message is sent to the terminal device. The RRC reject message carries the reject message authentication code for integrity (RejectMAC-I). The first indication information is sent to the terminal device. The first indication information is configured to indicate to the terminal device that the reject message authentication code for integrity (RejectMAC-I) is available in the random access network notification area (RNA). Therefore, a network device at a non-anchor can also send an RRC reject message that is secured. Thus security and robustness of transmitting the RRC reject message in a radio access network (RAN) are effectively improved, and the security problem caused by tampering of the RRC reject message is avoided.

With reference to FIG. 5, FIG. 5 is a flowchart of a method for transmitting a radio resource control (RRC) reject message according to an example of the disclosure. It should be noted that the method for transmitting a radio resource control (RRC) reject message in the example of the disclosure is performed by the second network device. The second network device is a network device at an anchor, and may also be referred to as an old network device, which means that a serving cell corresponding to the second network device is a last serving cell of the terminal device, that is, the second network device is a network device to which the terminal device established an RRC connection last time.

As shown in FIG. 5, the method may include following steps.

Step 501. Send target indication information to a first network device in response to determining that the first network device rejects access of a terminal device, where the target indication information is configured to send a radio resource control (RRC) reject message to the terminal device.

The terminal device sends an RRC resume request to the first network device. The first network device may reject the access of the terminal device according to its own network condition, such as network congestion, and obtain the target indication information from the second network device.

Since the serving cell corresponding to the second network device is the last serving cell of the terminal device, that is, the second network device has established an RRC connection to the terminal device, the context information of the terminal device is stored in both the second network device and the terminal device.

In some examples, the target indication information is at least one of the context of the terminal device and the reject message authentication code for integrity (RejectMAC-I).

As a first possible implementation, in response to rejecting the access of the terminal device by the first network device, the context of the terminal device is sent to the first network device.

As a second possible implementation, in response to rejecting the access of the terminal device by the first network device, the reject message authentication code for integrity (RejectMAC-I) is sent to the first network device.

As a third possible implementation, in response to rejecting the access of the terminal device by the first network device, the context of the terminal device and the reject message authentication code for integrity (RejectMAC-I) are sent to the first network device.

The reject message authentication code for integrity (RejectMAC-I) is calculated and generated through a certain algorithm according to the parameter information in the context of the terminal device. The terminal device can determine the validity of the RRC reject message according to the RejectMAC-I.

In some examples, the RejectMAC-I is calculated and generated according to the parameter information through an integrity algorithm for 5G (NIA).

In some examples, the context of the terminal device includes at least one of: a key, a bear ID, a data transmission direction, a sequence number (COUNT value), a source cell radio network temporary identifier (source C-RNTI), a source physical cell identifier (source PCI), a target cell-ID, a resumeCause, and a waitTime.

It can be understood that the target indication information is configured to send the radio resource control (RRC) reject message to the terminal device, which means that the first network device can send the radio resource control (RRC) reject message to the terminal device according to the target indication information.

In the example of the disclosure, the second network device may further send second indication information to the terminal device. The second indication information is configured to indicate to the terminal device that the reject message authentication code for integrity (RejectMAC-I) is available in the entire RNA.

In some examples, the second indication information is a system message or an RRC release message. That is, the second network device may indicate to the terminal device through the system message or the RRC release message that a network supports the reject message authentication code for integrity (RejectMAC-I) in the entire RNA, and the terminal device may use the reject message authentication code for integrity (RejectMAC-I) to determine the validity of the RRC reject message.

In the example of the disclosure, the second network device further receives security capability indication information reported by the terminal device. The security capability indication information is configured to indicate that the terminal device has a capability of determining the validity of the RRC reject message according to the reject message authentication code for integrity (RejectMAC-I).

In summary, the target indication information is sent to the first network device in response to rejecting the access of the terminal device by the first network device. The target indication information is configured to send the radio resource control (RRC) reject message to the terminal device, such that the network device at a non-anchor can also send the RRC reject message that is secured. Thus security and robustness of transmitting the RRC reject message in the radio access network (RAN) are effectively improved, and the security problem caused by tampering of the RRC reject message is avoided.

With reference to FIG. 6, FIG. 6 is a flowchart of a method for transmitting a radio resource control (RRC) reject message according to an example of the disclosure. It should be noted that the method for transmitting a radio resource control (RRC) reject message in the example of the disclosure is performed by the second network device. Relevant description about the second network device is as described above, and is not repeated here.

As shown in FIG. 6, the method may include following steps.

Step 601. Receive first signaling sent from a first network device, where the first signaling is configured to request a context of a terminal device from a second network device.

The first network device requests the context of the terminal device from the second network device by sending the first signaling to the second network device. After receiving the first signaling, the second network device can retrieve the context of the terminal device.

In some examples, the first signaling is a retrieve UE context request, or, the first signaling is custom signaling transmitted through an Xn interface.

The second network device retrieves the context of the terminal device requested by the first network device by receiving the retrieve UE context request sent from the first network device, or receiving the custom signaling transmitted through the Xn interface.

The Xn interface is a network interface for exchanging signaling information between network devices in a radio access network (RAN).

In some examples, the custom signaling includes an identifier of the terminal device, such that the second network device can obtain the context of the corresponding terminal device after receiving the custom signaling.

Step 602. Send second signaling to the first network device, where the second signaling is configured to provide the context of the terminal device.

After retrieving the context of the terminal device, the second network device forwards the context of the terminal device by returning the second signaling to the first network device.

In some examples, the second signaling is a retrieve UE context response, or, the second signaling is custom signaling transmitted through an Xn interface.

The second network device provides the context of the terminal device for the first network device by sending the retrieve UE context response to the first network device, or sending the custom signaling transmitted through the Xn interface.

In some examples, the custom signaling includes the identifier of the terminal device, such that the first network device determines that the received context belongs to the terminal device after receiving the custom signaling.

Step 603. Send second indication information to the terminal device, where the second indication information is configured to indicate to the terminal device that the reject message authentication code for integrity (RejectMAC-I) is available in a random access network notification area (RNA).

In some examples, the second indication information is a system message or an RRC release message.

That is, the second network device may indicate to the terminal device through the system message or to the terminal device through the RRC release message that a network supports the reject message authentication code for integrity (RejectMAC-I) in the entire RNA, and the terminal device may use the reject message authentication code for integrity (RejectMAC-I) to determine the validity of the RRC reject message.

Step 604. Receive security capability indication information sent from the terminal device.

The security capability indication information is configured to indicate that the terminal device has a capability of determining the validity of the RRC reject message according to the reject message authentication code for integrity (RejectMAC-I).

When the terminal device performs an RRC connection to the second network device, the terminal device reports the security capability indication information to the second network device, so as to inform the second network device that the terminal device has the capability of determining the validity of the RRC reject message according to the reject message authentication code for integrity (RejectMAC-I).

In some examples, the security capability indication information is at least one of: a UE capability information message, a security mode complete message, UE assistance information, an RRC setup complete, an RRC setup request, an RRC resume request, and a preamble.

That is, the terminal device may report that the terminal device has the security capability to the second network device through at least one of the UE capability information message, the security mode complete message, the UE assistance information, the RRC setup complete, the RRC setup request, the RRC resume request and the preamble.

In summary, the first signaling sent from the first network device is received. The first signaling is configured to request the context of the terminal device from the second network device. The second signaling is sent to the first network device. The second signaling is configured to provide the context of the terminal device. The second indication information is sent to the terminal device. The second indication information is configured to indicate to the terminal device that the reject message authentication code for integrity (RejectMAC-I) is available in the random access network notification area (RNA). The security capability indication information sent from the terminal device is received. Therefore, the network device at a non-anchor can also send the RRC reject message that is secured. Thus security and robustness of transmitting the RRC reject message in the radio access network (RAN) are effectively improved, and the security problem caused by tampering of the RRC reject message is avoided.

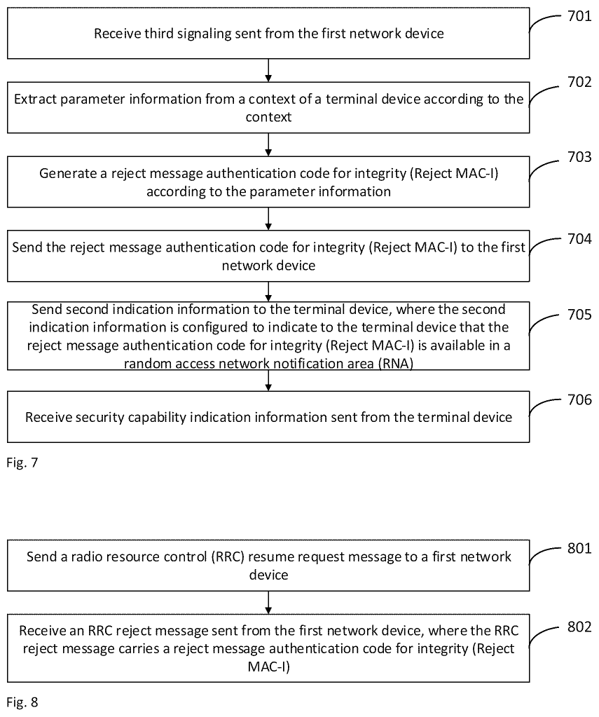

With reference to FIG. 7, FIG. 7 is a flowchart of a method for transmitting a radio resource control (RRC) reject message according to an example of the disclosure. It should be noted that the method for transmitting a radio resource control (RRC) reject message in the example of the disclosure is performed by the second network device. Relevant description about the second network device is as described above, and is not repeated here.

As shown in FIG. 7, the method may include following steps.

Step 701. Receive third signaling sent from a first network device.

The third signaling is configured to trigger the second network device to generate the reject message authentication code for integrity (RejectMAC-I) according to the context of the terminal device.

The first network device sends the third signaling to the second network device, so as to trigger the second network device to generate the reject message authentication code for integrity (RejectMAC-I) according to the context of the terminal device.

In some embodiments, the third signaling includes the identifier of the terminal device, so as to trigger the second network device to query the context of the terminal device and generate the RejectMAC-I according to the context of the terminal device.

It can be understood that after receiving the third signaling sent from the first network device, the second network device queries the context of the terminal device corresponding to the third signaling.

Step 702. Extract parameter information from a context of a terminal device according to the context.

After receiving the third signaling, the second network device retrieves the context of the terminal device, and then extracts the parameter information from the context to calculate a reject message authentication code for integrity (RejectMAC-I).

In some embodiments, the parameter information includes at least one of: a key, a bear ID, a data transmission direction, a sequence number (COUNT value), a source cell radio network temporary identifier (source C-RNTI), a source physical cell identifier (source PCI), a target cell-ID, a resumeCause, and a waitTime.

Step 703. Generate a reject message authentication code for integrity (RejectMAC-I) according to the parameter information.

The second network device extracts the parameter information from the context, calculates and generates the reject message authentication code for integrity (RejectMAC-I) according to the parameter information through a certain algorithm.

In some embodiment, the authentication code for integrity (RejectMAC-I) is calculated and generate through the NIA according to the parameter information.

In some examples, the parameter information includes at least one of: a key, a bear ID, a data transmission direction, a sequence number (COUNT value), a source cell radio network temporary identifier (source C-RNTI), a source physical cell identifier (source PCI), a target cell-ID, a resumeCause, and a waitTime.

Step 704. Send the reject message authentication code for integrity (RejectMAC-I) to the first network device.

After calculating and generating the reject message authentication code for integrity (RejectMAC-I) according to the parameter information in the context, the second network device sends the reject message authentication code for integrity (RejectMAC-I) to the first network device, such that the first network device sends the RRC reject message carrying the RejectMAC-I to the terminal device according to the reject message authentication code for integrity (RejectMAC-I).

Step 705. Send second indication information to the terminal device, where the second indication information is configured to indicate to the terminal device that the reject message authentication code for integrity (RejectMAC-I) is available in a random access network notification area (RNA).

In the example of the disclosure, step 705 may be implemented in any manner of the example of the disclosure, which is not limited by the example of the disclosure and will not be repeated here.

Step 706. Receive security capability indication information sent from the terminal device.

The security capability indication information is configured to indicate that the terminal device has a capability of determining the validity of the RRC reject message according to the reject message authentication code for integrity (RejectMAC-I).

In the example of the disclosure, step 706 may be implemented in any manner of the example of the disclosure, which is not limited by the example of the disclosure and will not be repeated here.

In summary, the third signaling sent from the first network device is received. The parameter information is extracted from the context of the terminal device according to the context. The reject message authentication code for integrity (RejectMAC-I) is generated according to the parameter information. The reject message authentication code for integrity (RejectMAC-I) is sent to the first network device. The second indication information is sent to the terminal device. The second indication information is configured to indicate to the terminal device that the reject message authentication code for integrity (RejectMAC-I) is available in the random access network notification area (RNA). The security capability indication information sent from the terminal device is received. Therefore, the network device at a non-anchor can also send the RRC reject message that is secured. Thus security and robustness of transmitting the RRC reject message in the radio access network (RAN) are effectively improved, and the security problem caused by tampering of the RRC reject message is avoided.

With reference to FIG. 8, FIG. 8 is a flowchart of a method for transmitting a radio resource control (RRC) reject message according to an example of the disclosure. It should be noted that the method for transmitting a radio resource control (RRC) reject message in the example of the disclosure is performed by the terminal device. As shown in FIG. 8, the method may include following steps.

Step 801. Send a radio resource control (RRC) resume request message to a first network device.

The terminal device in an inactive state can move through the entire RNA and can send the RRC resume request to any network device in the RNA. The first network device is a network device in the RNA, and the serving cell corresponding to the first network device is different from the last serving cell of the terminal device.

It can be understood that the first network device may determine whether to approve the resume request of the terminal device and establish an RRC connection to the terminal device according to its own network condition, such as network congestion.

Step 802. Receive an RRC reject message sent from the first network device, where the RRC reject message carries a reject message authentication code for integrity (RejectMAC-I).

The terminal device receives the RRC reject message carrying the reject message authentication code for integrity (RejectMAC-I) sent from the first network device. The terminal device can determine the validity of the RRC reject message according to the RejectMAC-I.

The reject message authentication code for integrity (RejectMAC-I) is calculated and generated by the first network device or the second network device according to the parameter information in the context of the terminal device. Since the RejectMAC-I is calculated and generated according to the parameter information in the context through a certain algorithm, the terminal device may calculate and generate a RejectMAC-I according to the parameter information in the context stored by the terminal device through the same algorithm. After receiving the authentication code, the terminal device may perform matching verification on the received RejectMAC-I and the RejectMAC-I calculated and generated by the terminal device, and in a case that comparison and matching succeeds, the verification passes, indicating that the RRC reject message is valid.

In some embodiments, in a case that the terminal device determines that the RRC reject message is valid, the terminal device waits for a timer in a reject waitTime information element (IE) in the RRC reject message to expire, and resends the RRC resume request.

In some embodiments, in a case that the terminal device determines that the RRC reject message is invalid, the terminal device omits the RRC reject message, that is, it is considered that the terminal device receives no RRC reject message, waits for a T319 timer to expire, and enters an IDLE state.

In the embodiment of the disclosure, the terminal device may further receive the indication information sent from the network device. The indication information is configured to indicate to the terminal device that the message authentication code for integrity (RejectMAC-I) is available in the entire RNA.

In some examples, the network device is the first network device or the second network device.

The first network device sends the first indication information to the terminal device. The second network device sends the second indication information to the terminal device.

In some examples, the first indication information is a system message. That is, the first network device may indicate to the terminal device through the system message that a network supports the reject message authentication code for integrity (RejectMAC-I) in the entire RNA, and the terminal device may use the reject message authentication code for integrity (RejectMAC-I) to determine the validity of the RRC reject message.

In some examples, the second indication information is a system message or an RRC release message. That is, the second network device may indicate to the terminal device through the system message or the RRC release message that a network supports the reject message authentication code for integrity (RejectMAC-I) in the entire RNA, and the terminal device may use the reject message authentication code for integrity (RejectMAC-I) to determine the validity of the RRC reject message.

In some embodiments, in a case that the terminal device receives the indication information from the network device, where the indication information is configured to indicate to the terminal device that the RejectMAC-I is available in the entire RNA, and the terminal device receives the RRC reject message that does not include the RejectMAC-I, the RRC reject message is considered invalid, and the RRC reject message is omitted, that is, it is considered that the terminal device receives no RRC reject message, and waits for the T319 timer to expire.

In the example of the disclosure, when establishing an RRC connection to the second network device, the terminal device reports the security capability indication information to the second network device. The security capability indication information is configured to indicate that the terminal device has a capability of determining the validity of the RRC reject message according to the reject message authentication code for integrity (RejectMAC-I).

In summary, the radio resource control (RRC) resume request message is sent to the first network device, and the RRC reject message sent from the first network device is received. The RRC reject message carries the reject message authentication code for integrity (RejectMAC-I), such that the terminal device can receive the RRC reject message that is secured, and determine the validity of the reject message according to the received RRC reject message that is secured. Thus security and robustness of transmitting the RRC reject message in the radio access network (RAN) are effectively improved, and the security problem caused by tampering of the RRC reject message is avoided.

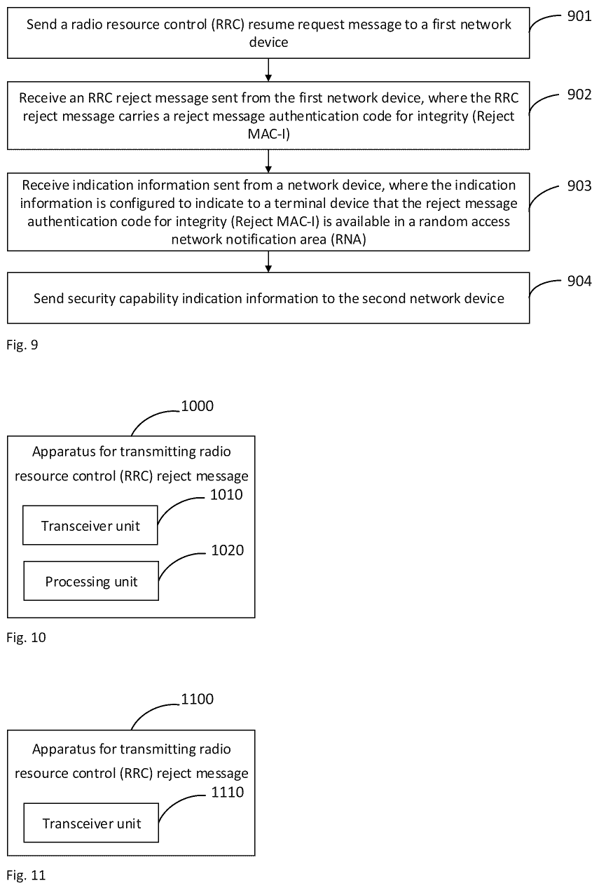

With reference to FIG. 9, FIG. 9 is a flowchart of a method for transmitting a radio resource control (RRC) reject message according to an example of the disclosure. It should be noted that the method for transmitting a radio resource control (RRC) reject message in the example of the disclosure is performed by the terminal device. As shown in FIG. 9, the method may include following steps.

Step 901. Send a radio resource control (RRC) resume request message to a first network device.

In the example of the disclosure, step 901 may be implemented in any manner of the example of the disclosure, which is not limited by the example of the disclosure and will not be repeated here.

Step 902. Receive an RRC reject message sent from the first network device, where the RRC reject message carries a reject message authentication code for integrity (RejectMAC-I).

The terminal device receives the RRC reject message carrying the reject message authentication code for integrity (RejectMAC-I) sent from the first network device. The terminal device can determine the validity of the RRC reject message according to the RejectMAC-I.

In some embodiments, in a case that the terminal device determines that the RRC reject message is valid, the terminal device waits for a timer in a reject waitTime information element (IE) in the RRC reject message to expire, and resends the RRC resume request.

In some embodiments, in a case that the terminal device determines that the RRC reject message is invalid, the terminal device omits the RRC reject message, that is, it is considered that the terminal device receives no RRC reject message, waits for a T319 timer to expire, and enters an IDLE state.

In some embodiments, in a case that the terminal device receives the indication information from the network device, where the indication information is configured to indicate to the terminal device that the RejectMAC-I is available in the entire RNA, and the terminal device receives the RRC reject message that does not include the RejectMAC-I, the RRC reject message is considered invalid, and the RRC reject message is omitted, that is, it is considered that the terminal device receives no RRC reject message, and waits for the T319 timer to expire.

Step 903. Receive indication information sent from a network device, where the indication information is configured to indicate to a terminal device that the reject message authentication code for integrity (RejectMAC-I) is available in a random access network notification area (RNA).

In some examples, the network device is the first network device or the second network device.

The first network device sends the first indication information to the terminal device. The second network device sends the second indication information to the terminal device.

In some examples, the first indication information is a system message. That is, the first network device may indicate to the terminal device through the system message that a network supports the reject message authentication code for integrity (RejectMAC-I) in the entire RNA, and the terminal device may use the reject message authentication code for integrity (RejectMAC-I) to determine the validity of the RRC reject message.

In some examples, the second indication information is a system message or an RRC release message. That is, the second network device may indicate to the terminal device through the system message or the RRC release message that a network supports the reject message authentication code for integrity (RejectMAC-I) in the entire RNA, and the terminal device may use the reject message authentication code for integrity (RejectMAC-I) to determine the validity of the RRC reject message.

Step 904. Send security capability indication information to a second network device.

The security capability indication information is configured to indicate that the terminal device has a capability of determining the validity of the RRC reject message according to the reject message authentication code for integrity (RejectMAC-I).

When the terminal device performs an RRC connection to the second network device, the terminal device reports the security capability indication information to the second network device, so as to inform the second network device that the terminal device has the capability of determining the validity of the RRC reject message according to the reject message authentication code for integrity (RejectMAC-I).

In some examples, the security capability indication information is at least one of: a UE capability information message, a security mode complete message, UE assistance information, an RRC setup complete, an RRC setup request, an RRC resume request, and a preamble.

That is, the terminal device may report that the terminal device has the security capability to the second network device through at least one of the UE capability information message, the security mode complete message, the UE assistance information, the RRC setup complete, the RRC setup request, the RRC resume request and the preamble.

In summary, the radio resource control (RRC) resume request message is sent to the first network device, and the RRC reject message sent from the first network device is received. The RRC reject message carries the reject message authentication code for integrity (RejectMAC-I). The indication information sent from a network device is received. The indication information is configured to indicate to the terminal device that the reject message authentication code for integrity (RejectMAC-I) is available in the random access network notification area (RNA). The security capability indication information is sent to the second network device. Therefore, the terminal device can receive the RRC reject message that is secured, and determine the validity of the reject message according to the received RRC reject message that is secured. Thus security and robustness of transmitting the RRC reject message in the radio access network (RAN) are effectively improved, and the security problem caused by tampering of the RRC reject message is avoided.

Corresponding to the method for transmitting a radio resource control (RRC) reject message provided in the above examples, the disclosure further provides an apparatus for transmitting a radio resource control (RRC) reject message. Since the apparatus for transmitting a radio resource control (RRC) reject message provided in the examples of the disclosure corresponds to the method provided in the above examples, an embodiment of the method for transmitting a radio resource control (RRC) reject message is also applicable to the apparatus for transmitting a radio resource control (RRC) reject message provided in the following examples. It will not be described in detail in the following examples.

With reference to FIG. 10, FIG. 10 is a schematic structural diagram of an apparatus for transmitting a radio resource control (RRC) reject message according to an example of the disclosure.

As shown in FIG. 10, the apparatus 1000 for transmitting a radio resource control (RRC) reject message includes a transceiver unit 1010 and a processing unit 1020.

The transceiver unit 1010 is configured to receive a radio resource control (RRC) resume request message sent from a terminal device.

The processing unit 1020 is configured to obtain target indication information from a second network device in response to rejecting access of the terminal device.

The transceiver unit 1010 is further configured to send the radio resource control (RRC) reject message to the terminal device according to the target indication information.

In some examples, the target indication information is a context of the terminal device, and the transceiver unit 1010 is specifically configured to: extract parameter information from the context of the terminal device according to the context; generate a reject message authentication code for integrity (RejectMAC-I) according to the parameter information; and send the RRC reject message to the terminal device, where the RRC reject message carries the reject message authentication code for integrity (RejectMAC-I).

In some examples, the parameter information includes at least one of: a key, a bear ID, a data transmission direction, a sequence number (COUNT value), a source cell radio network temporary identifier (source C-RNTI), a source physical cell identifier (source PCI), a target cell-ID, a resumeCause, and a waitTime.

In some examples, the target indication information is a reject message authentication code for integrity (RejectMAC-I), and the transceiver unit 1010 is specifically configured to send the RRC reject message to the terminal device, where the RRC reject message carries the reject message authentication code for integrity (RejectMAC-I).

In some examples, the processing unit 1020 is specifically configured to: send first signaling to the second network device in response to rejecting the access of the terminal device, where the first signaling is configured to request the context of the terminal device from the second network device; and receive second signaling sent from the second network device, where the second signaling is configured to provide the context of the terminal device.

In some examples, the first signaling is a retrieve UE context request, or, the first signaling is custom signaling transmitted through an Xn interface.

In some examples, the second signaling is a retrieve UE context response, or, the second signaling is custom signaling transmitted through an Xn interface.

In some examples, the processing unit 1020 is specifically configured to: send third signaling to the second network device in response to rejecting the access of the terminal device, where the third signaling is configured to trigger the second network device to generate the reject message authentication code for integrity (RejectMAC-I) according to the context of the terminal device; and receive the reject message authentication code for integrity (RejectMAC-I) sent from the second network device.

In some examples, the reject message authentication code for integrity (RejectMAC-I) is configured to determine validity of the RRC reject message.

In some examples, the transceiver unit 1010 is further configured to send first indication information to the terminal device, where the first indication information is configured to indicate to the terminal device that the reject message authentication code for integrity (RejectMAC-I) is available in a random access network notification area (RNA).

The apparatus for transmitting a radio resource control (RRC) reject message in the example may obtain the target indication information from the second network device by receiving the radio resource control (RRC) resume request message sent from the terminal device in response to rejecting the access of the terminal device, and may send the radio resource control (RRC) reject message to the terminal device according to the target indication information, such that the network device at a non-anchor can also send the RRC reject message that is secured. Thus security and robustness of transmitting the RRC reject message in the radio access network (RAN) are effectively improved, and the security problem caused by tampering of the RRC reject message is avoided.

With reference to FIG. 11, FIG. 11 is a schematic structural diagram of an apparatus for transmitting a radio resource control (RRC) reject message according to an example of the disclosure.

As shown in FIG. 11, the apparatus 1100 for transmitting a radio resource control (RRC) reject message includes a transceiver unit 1110.

The transceiver unit 1110 is configured to send target indication information to a first network device in response to determining that the first network device rejects access of a terminal device. The target indication information is configured to send the radio resource control (RRC) reject message to the terminal device.

In some examples, the target indication information is a context of the terminal device, and the transceiver unit 1110 is specifically configured to: receive first signaling sent from the first network device, where the first signaling is configured to request the context of the terminal device from the second network device, and the terminal device is a terminal device requesting radio resource control (RRC) resume from the first network device; and send second signaling to the first network device, where the second signaling is configured to provide the context of the terminal device.

In some examples, the context of the terminal device includes at least one of: a key, a bear ID, a data transmission direction, a sequence number (COUNT value), a source cell radio network temporary identifier (source C-RNTI), a source physical cell identifier (source PCI), a target cell-ID, a resumeCause, and a waitTime.

In some examples, the first signaling is a retrieve UE context request, or, the first signaling is custom signaling transmitted through an Xn interface.

In some examples, the second signaling is a retrieve UE context response, or, the second signaling is custom signaling transmitted through an Xn interface.

In some examples, the target indication information is a reject message authentication code for integrity (RejectMAC-I). The transceiver unit 1110 is specifically configured to: receive third signaling sent from the first network device; extract parameter information from a context of the terminal device according to the context; generate the reject message authentication code for integrity (RejectMAC-I) according to the parameter information; and send the reject message authentication code for integrity (RejectMAC-I) to the first network device.

In some examples, the reject message authentication code for integrity (RejectMAC-I) is configured to instruct the terminal device to determine the validity of the RRC reject message according to the reject message authentication code for integrity (RejectMAC-I).

In some examples, the transceiver unit 1110 is further configured to send second indication information to the terminal device, where the second indication information is configured to indicate to the terminal device that the reject message authentication code for integrity (RejectMAC-I) is available in a random access network notification area (RNA).

In some examples, the transceiver unit 1110 is further configured to receive security capability indication information sent from the terminal device, where the capability indication information is configured to indicate that the terminal device has a capability of determining the validity of the RRC reject message according to the reject message authentication code for integrity (RejectMAC-I).

The apparatus for transmitting a radio resource control (RRC) reject message in the example may send the target indication information to the first network device in response to rejecting the access of the terminal device by the first network device. The target indication information is configured to send the radio resource control (RRC) reject message to the terminal device, such that the network device at a non-anchor can also send the RRC reject message that is secured. Thus security and robustness of transmitting the RRC reject message in a radio access network (RAN) are effectively improved, and the security problem caused by tampering of the RRC reject message is avoided.

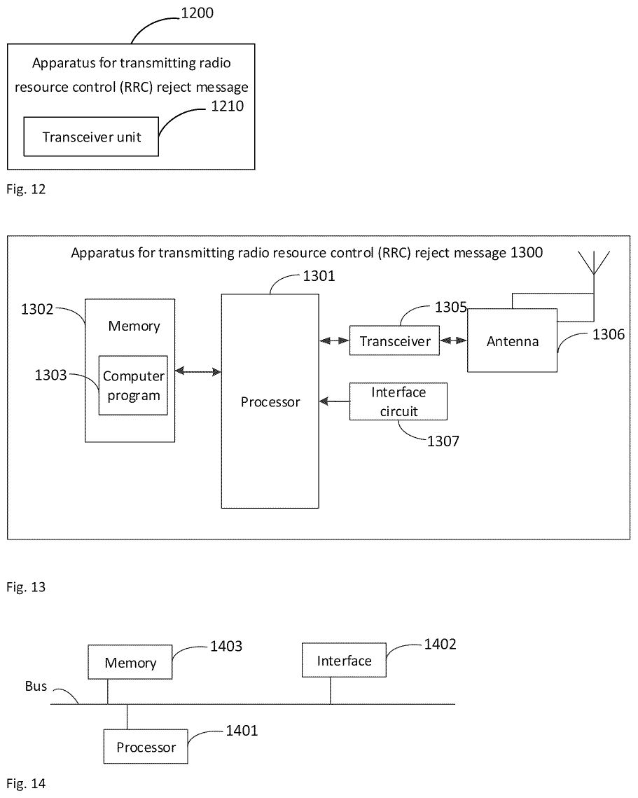

With reference to FIG. 12, FIG. 12 is a schematic structural diagram of an apparatus for transmitting a radio resource control (RRC) reject message according to an example of the disclosure.

As shown in FIG. 12, the apparatus 1200 for transmitting a radio resource control (RRC) reject message includes a transceiver unit 1210.

The transceiver unit 1210 is configured to send a radio resource control (RRC) resume request message to a first network device.

The transceiver unit 1210 is further configured to receive the RRC reject message sent from the first network device, where the RRC reject message carries a reject message authentication code for integrity (RejectMAC-I).

In some examples, the reject message authentication code for integrity (RejectMAC-I) is configured to determine validity of the RRC reject message.

In some examples, the transceiver unit 1210 is further configured to receive indication information sent from a network device, where the indication information is configured to indicate to the terminal device that the reject message authentication code for integrity (RejectMAC-I) is available in a random access network notification area (RNA).

In some examples, the transceiver unit 1210 is further configured to send security capability indication information to a second network device, where the capability indication information is configured to indicate that the terminal device has a capability of determining the validity of the RRC reject message according to the reject message authentication code for integrity (RejectMAC-I).

The apparatus for transmitting a radio resource control (RRC) reject message in the example may receive the RRC reject message sent from the first network device by sending the radio resource control (RRC) resume request message to the first network device. The RRC reject message carries the reject message authentication code for integrity (RejectMAC-I), such that the terminal device can receive the RRC reject message that is secured, and determine the validity of the reject message according to the received RRC reject message that is secured. Thus security and robustness of transmitting the RRC reject message in the radio access network (RAN) are effectively improved, and the security problem caused by tampering of the RRC reject message is avoided.

In order to implement the above examples, the example of the disclosure further provides a communication apparatus. The communication apparatus includes a processor and a memory. The memory stores a computer program. The processor executes the computer program stored in the memory, so as to cause the apparatus to perform the methods in FIGS. 2-4 or to perform the method in FIGS. 5-7.

In order to implement the above examples, the example of the disclosure further provides a communication apparatus. The communication apparatus includes a processor and a memory. The memory stores a computer program. The processor executes the computer program stored in the memory, so as to cause the apparatus to perform the methods in FIGS. 8-9.

In order to implement the above examples, the example of the disclosure further provides a communication apparatus. The communication apparatus includes a processor and an interface circuit. The interface circuit is configured to receive a code instruction and transmit the code instruction to the processor. The processor is configured to run the code instruction, so as to perform the methods of the examples in FIGS. 2-4 or to perform the methods of the examples in FIGS. 5-7.

In order to implement the above examples, the example of the disclosure further provides a communication apparatus. The communication apparatus includes a processor and an interface circuit. The interface circuit is configured to receive a code instruction and transmit the code instruction to the processor. The processor is configured to run the code instruction, so as to perform the methods of the examples in FIGS. 8-9.

With reference to FIG. 13, FIG. 13 is a schematic structural diagram of another apparatus for transmitting a radio resource control (RRC) reject message according to an example of the disclosure. The apparatus 1300 for transmitting a radio resource control (RRC) reject message may be a network device, may be a terminal device, may be a chip, a chip system, or a processor that supports a network device to implement the above method, and may also be a chip, a chip system, or a processor that supports a terminal device to implement the above method. The apparatus may be configured to implement the methods described in the above method examples, and reference may be made to description in the above method examples for details.

The apparatus 1300 for transmitting a radio resource control (RRC) reject message may include one or more processors 1301. The processor 1301 may be a general purpose processor or a special purpose processor, etc., such as a baseband processor or a central processor. The baseband processor may be configured to process a communication protocol and communication data. The central processor may be configured to control an apparatus (for example, a base station, a baseband chip, a terminal device, a terminal device chip, a DU or a CU) for transmitting a radio resource control (RRC) reject message, execute a computer program, and process data of the computer program.

In some examples, the apparatus 1300 for transmitting a radio resource control (RRC) reject message may further include one or more memories 1302 that may store a computer program 1303. The processor 1301 executes the computer program 1303 to cause the apparatus 1300 for transmitting a radio resource control (RRC) reject message to perform the method described in the above method examples. The computer program 1303 may be embedded in the processor 1301. In this case, the processor 1301 may be implemented by hardware.

In some examples, the memory 1302 may also store data. The apparatus 1300 for transmitting a radio resource control (RRC) reject message and the memory 1302 may be set separately or may be integrated together.

In some examples, the apparatus 1300 for transmitting a radio resource control (RRC) reject message may further include a transceiver 1305 and an antenna 1306. The transceiver 1305 may be referred to as a transceiver unit, a transceiver machine, or a transceiver circuit, etc., and is configured to implement transmit-receive function. The transceiver 1305 may include a receiver and a transmitter. The receiver may be referred to as a receiver machine or a receiving circuit, etc., for implementing a reception function. The transmitter may be referred to as a transmitter machine or a sending circuit, etc., for implementing a transmission function.

In some examples, the apparatus 1300 for transmitting a radio resource control (RRC) reject message may further include one or more interface circuits 1307. The interface circuit 1307 is configured to receive a code instruction and transmit the code instruction to the processor 1301. The processor 1301 executes the code instruction to cause the apparatus 1300 for transmitting a radio resource control (RRC) reject message to perform the method described in the above method examples.

When the apparatus 1300 for transmitting a radio resource control (RRC) reject message is a terminal device, the transceiver 1305 is configured to perform steps 801-802 in FIG. 8 and steps 901-904 in FIG. 9.

When the apparatus 1300 for transmitting a radio resource control (RRC) reject message is a network device, the transceiver 1305 is configured to perform steps 201 and 203 in FIG. 2, steps 301, 306 and 307 in FIG. 3, steps 401, 404 and 405 in FIG. 4, step 501 in FIG. 5, steps 601-604 in FIG. 6, and steps 701-706 in FIG. 7, and the processor 1301 is configured to perform step 202 in FIG. 2, steps 302-305 in FIG. 3, and steps 402-403 in FIG. 4.

In an implementation manner, the processor 1301 may include a transceiver for implementing a reception function and a transmission function. For example, the transceiver may be a transceiver circuit, or an interface, or an interface circuit. The transceiver circuit, interface, or interface circuit for implementing the reception function and the transmission function may be separated or integrated. The transceiver circuit, interface or interface circuit may be configured to read and write a code/data, and alternatively, the transceiver circuit, interface or interface circuit may be configured to transmit or transfer a signal.

In an implementation manner, the apparatus 1300 for transmitting a radio resource control (RRC) reject message may include a circuit that may implement the functions of transmission, reception or communication in the foregoing method examples. The processor and transceiver described in the disclosure may be implemented on an integrated circuit (ICs), an analog IC, a radio frequency integrated circuit (RFIC), a mixed-signal IC, an application specific integrated circuit (ASIC), a printed circuit board (PCB), an electronic device, etc. The processor and transceiver may also be fabricated using various IC process technologies, such as a complementary metal oxide semiconductor (CMOS), an n-metal-oxide-semiconductor (NMOS), a positive channel metal oxide semiconductor (PMOS), a bipolar junction transistor (BJT), a bipolar CMOS (BiCMOS), silicon germanium (SiGe), gallium arsenide (GaAs), etc.

The apparatus for transmitting a radio resource control (RRC) reject message described in the above examples may be a network device or a terminal device. The scope of the apparatus for transmitting a radio resource control (RRC) reject message described in the disclosure is not limited thereto, and a structure of the apparatus for transmitting a radio resource control (RRC) reject message may not be limited by FIGS. 10-12. The apparatus for transmitting a radio resource control (RRC) reject message may be a stand-alone device or may be part of a larger device. For example, the apparatus for transmitting a radio resource control (RRC) reject message may be:
(1) an independent integrated circuit (IC), a chip, a chip system or a subsystem;
(2) a set including one or more ICs, where in some examples, the IC set may also include a memory component configured to store data and a computer programs;
(3) an ASIC, such as a modem;
(4) a module that can be embedded in other devices;
(5) a receiver machine, a terminal device, an intelligent terminal device, a cellular phone, a radio device, a handset, a mobile unit, a vehicle-mounted device, a network device, a cloud device, an artificial intelligence device, etc.; and
(6) other apparatuses, etc.

Reference may be made to a schematic structural diagram of a chip shown in FIG. 14 for the case that the apparatus for transmitting a radio resource control (RRC) reject message may be a chip or a chip system. The chip shown in FIG. 14 includes a processor 1401 and an interface 1402. One or more processors 1401 may be provided. A plurality of interfaces 1402 may be provided.

The case that the chip is configured to implement the function of the network device in the example of the disclosure is as follows.

The interface 1402 is configured to receive a code instruction and transmit the code instruction to the processor.

The processor 1401 is configured to run the code instruction, so as to perform the methods in FIGS. 2-4, or to perform the methods in FIGS. 5-7.

The case that the chip is configured to implement the function of the terminal device in the example of the disclosure is as follows.

The interface 1402 is configured to receive a code instruction and transmit the code instruction to the processor.

The processor 1401 is configured to run the code instruction, so as to perform the methods in FIGS. 8-9.

In some examples, the chip further includes a memory 1403. The memory 1403 is configured to store a needed computer program and data.

Those skilled in the art will further appreciate that the various illustrative logical blocks and steps set forth in the examples of the disclosure may be implemented by electronic hardware, computer software, or combinations of both. Whether such functions are implemented in hardware or software depends on a particular application and overall system design requirements. Those skilled in the art may use various methods to implement the functions for each particular application, but such implementation should not be understood to be beyond the scope of protection of the examples of the disclosure.

The examples of the disclosure further provide a communication system. The system includes the apparatus for transmitting a radio resource control (RRC) reject message as a terminal device and the apparatus for transmitting a radio resource control (RRC) reject message as a network device in the examples of FIGS. 10-12, or includes the apparatus for transmitting a radio resource control (RRC) reject message as a terminal device and the apparatus for transmitting a radio resource control (RRC) reject message as a network device in the example of FIG. 13.

The disclosure further provides a readable storage medium. The readable storage medium stores an instruction. The instruction implements the functions of any one of the method examples when performed by a computer.

The disclosure further provides a computer program product. The computer program product implements the functions of the method examples when performed by a computer.

The examples described above can be implemented in whole or in part by software, hardware, firmware, or any combination of them. When implemented by software, the examples can be implemented in whole or in part as a computer program product. The computer program product includes one or more computer programs. When loaded and performed on a computer, the computer program generates in whole or in part the flows or functions described in accordance with the examples of the disclosure. The computer may be a general purpose computer, a special purpose computer, a computer network, or other programmable apparatuses. The computer program may be stored in a computer-readable storage medium or transmitted from one computer-readable storage medium to another computer-readable storage medium. For example, the computer program can be transmitted from one website, computer, server, or data center to another website, computer, server, or data center in a mode of a wire (for example, coaxial cable, optical fiber, digital subscriber line (DSL)) or radio (for example, infrared, radio, microwave, etc.). The computer-readable storage medium may be any available medium that can be accessed by a computer or a data storage device including one or more available media integrated as a server, data center, etc. The available medium may be a magnetic medium (for example, floppy disk, hard disk, magnetic tape), an optical medium (for example, digital video disk (DVD)), or a semiconductor medium (for example, solid state disk (SSD)), etc.

Those skilled in the art may understand that the first, second and other numerical numbers referred to in the disclosure are merely for distinction for convenience of description, and are not intended to limit the scope of the examples of the disclosure, and also represent the sequence.

At least one in the disclosure may also be described as one or more, and the plurality may be two, three, four, or more, which are not limited in the disclosure. In the examples of the disclosure, for a type of technical features, technical features in this type of the technical features are distinguished by “first”, “second”, “third”, “A”, “B”, “C” and “D”, and the technical features described by the “first”, “second”, “third”, “A”, “B”, “C” and “D” have no sequence or order of magnitude.

Corresponding relations shown in tables of the disclosure may be configured or predefined. Values of information in each table are only instances, and may be configured to other values, which are not limited in the disclosure. When a corresponding relation between the information and each parameter is configured, it is not necessarily needed to configure all the corresponding relations indicated in each table. For example, in the tables of the disclosure, the corresponding relations shown in some rows may not be configured. For another example, appropriate deformation adjustments, such as splitting, merging, etc., can be made based on the above table. Names of the parameters shown in the titles of the above tables may also be other names that can be understood by the communication apparatus, and values or expression modes of the parameters may also be other values or expression modes that can be understood by the communication apparatus. When the tables are implemented, other data structures may also be used, such as an array, a queue, a container, a stack, a linear table, a pointer, a linked list, a tree, a graph, a structure, a class, a heap, or a hash table.

Predefinition in the disclosure may be understood as defining, predefining, storing, pre-storing, pre-negotiating, pre-configuring, curing, or pre-firing.

Those of ordinary skill in the art may appreciate that the units and algorithm steps of the instances described in conjunction with the examples disclosed here may be implemented in electronic hardware, or a combination of computer software and electronic hardware. Whether these functions are performed with hardware or software depends on the specific application and design constraints of the technical solution. Those skilled can implement the described functions with different methods for each particular application, but such implementation should not be considered to fall beyond the scope of the disclosure.

Those skilled in the art will clearly appreciate that, for convenience and conciseness of description, reference can be made to corresponding processes in the foregoing method examples for specific working processes of the above systems, devices and units, which are not repeated here.

It should be understood that the various forms of the flows shown above may be used, with steps being reordered, added, or deleted. For instance, steps described in the examples of the disclosure may be performed in parallel, performed sequentially, or performed in a different order, as long as desired results of the technical solutions disclosed in the disclosure can be achieved, which is not limited here.

The above specific embodiments do not limit the scope of protection of the disclosure. Those skilled in the art will appreciate that various modifications, combinations, subcombinations, and substitutions may occur according to design requirements and other factors. Any modifications, equivalent substitutions, improvements, etc. made within the spirit and principle of the disclosure should be included within the scope of protection of the disclosure.

Additional non-limiting embodiments of the disclosure include:

1. A method for transmitting a radio resource control (RRC) reject message, performed by a first network device, and including:
receiving an RRC resume request message sent from a terminal device;
obtaining target indication information from a second network device in response to rejecting access of the terminal device; and
sending the RRC reject message to the terminal device according to the target indication information.

2. The method according to embodiment 1, where the target indication information is a context of the terminal device, and sending the RRC reject message to the terminal device according to the target indication information includes:
extracting parameter information from the context of the terminal device according to the context;
generating a reject message authentication code for integrity (RejectMAC-I) according to the parameter information; and
sending the RRC reject message to the terminal device, where the RRC reject message carries the RejectMAC-I.

3. The method according to embodiment 2, where the parameter information includes at least one of: a key, a bear ID, a data transmission direction, a sequence number (COUNT value), a source cell radio network temporary identifier (source C-RNTI), a source physical cell identifier (source PCI), a target cell-ID, a resumeCause, and a waitTime.

4. The method according to embodiment 1, where the target indication information is a RejectMAC-I, and sending the RRC reject message to the terminal device according to the target indication information includes:

sending the RRC reject message to the terminal device, where the RRC reject message carries the RejectMAC-I.

5. The method according to embodiment 2, where obtaining the context of the terminal device from the second network device in response to rejecting the access of the terminal device includes:
sending first signaling to the second network device in response to rejecting the access of the terminal device, where the first signaling is configured to request the context of the terminal device from the second network device; and
receiving second signaling sent from the second network device, where the second signaling is configured to provide the context of the terminal device.

6. The method according to embodiment 5, where the first signaling is a retrieve UE context request, or, the first signaling is custom signaling transmitted through an Xn interface.

7. The method according to embodiment 5, where the second signaling is a retrieve UE context response, or, the second signaling is custom signaling transmitted through an Xn interface.

8. The method according to embodiment 4, where obtaining the RejectMAC-I from the second network device in response to rejecting the access of the terminal device includes:
sending third signaling to the second network device in response to rejecting the access of the terminal device, where the third signaling is configured to trigger the second network device to generate the RejectMAC-I according to the context of the terminal device; and
receiving the RejectMAC-I sent from the second network device.

9. The method according to any one of embodiments 1-8, where the RejectMAC-I is configured to determine validity of the RRC reject message.

10. The method according to embodiment 9, further including:
sending first indication information to the terminal device, where the first indication information is configured to indicate to the terminal device that the RejectMAC-I is available in a random access network notification area (RNA).

11. A method for transmitting a radio resource control (RRC) reject message, performed by a second network device, and including:
sending target indication information to a first network device in response to determining that the first network device rejects access of a terminal device, where the target indication information is configured to send the RRC reject message to the terminal device.

12. The method according to embodiment 11, where the target indication information is a context of the terminal device, and sending the target indication information to a first network device in response to determining that the first network device rejects access of a terminal device includes:
receiving first signaling sent from the first network device, where the first signaling is configured to request the context of the terminal device from the second network device, and the terminal device is a terminal device requesting RRC resume from the first network device; and
sending second signaling to the first network device, where the second signaling is configured to provide the context of the terminal device.

13. The method according to embodiment 12, where the context of the terminal device includes at least one of: a key, a bear ID, a data transmission direction, a sequence number (COUNT value), a source cell radio network temporary identifier (source C-RNTI), a source physical cell identifier (source PCI), a target cell-ID, a resumeCause, and a waitTime.

14. The method according to embodiment 12, where the first signaling is a retrieve UE context request, or, the first signaling is custom signaling transmitted through an Xn interface.

15. The method according to embodiment 12, where the second signaling is a retrieve UE context response, or, the second signaling is custom signaling transmitted through an Xn interface.

16. The method according to embodiment 11, where the target indication information is a reject message authentication code for integrity (RejectMAC-I), and sending the target indication information to the first network device in response to determining that the first network device rejects access of a terminal device includes:
receiving third signaling sent from the first network device;
extracting parameter information from a context of the terminal device according to the context;
generating the RejectMAC-I according to the parameter information; and
sending the RejectMAC-I to the first network device.

17. The method according to embodiment 16, where the RejectMAC-I is configured to determine validity of the RRC reject message.

18. The method according to any one of embodiments 11-17, further including:
sending second indication information to the terminal device, where the second indication information is configured to indicate to the terminal device that the RejectMAC-I is available in a random access network notification area (RNA).

19. The method according to embodiment 18, further including:
receiving security capability indication information sent from the terminal device, where the security capability indication information is configured to indicate that the terminal device has a capability of determining the validity of the RRC reject message according to the RejectMAC-I.

20. A method for transmitting a radio resource control (RRC) reject message, performed by a terminal device, and including:
sending an RRC resume request message to a first network device; and
receiving an RRC reject message sent from the first network device, where the RRC reject message carries a reject message authentication code for integrity (RejectMAC-I).

21. The method according to embodiment 20, where the RejectMAC-I is configured to determine validity of the RRC reject message.

22. The method according to embodiment 20 or 21, further including:
receiving indication information sent from a network device, where the indication information is configured to indicate to the terminal device that the RejectMAC-I is available in a random access network notification area (RNA).

23. The method according to embodiment 22, further including:
sending security capability indication information to a second network device, where the security capability indication information is configured to indicate that the terminal device has a capability of determining the validity of the RRC reject message according to the RejectMAC-I.

24. An apparatus for transmitting a radio resource control (RRC) reject message, suitable for a first network device, and including:
a transceiver unit configured to receive an RRC resume request message sent from a terminal device; and
a processing unit configured to obtain target indication information from a second network device in response to rejecting access of the terminal device; where
the transceiver unit is further configured to send the RRC reject message to the terminal device according to the target indication information.

25. The apparatus according to embodiment 24, where the target indication information is a context of the terminal device, and the transceiver unit is specifically configured to:
extract parameter information from the context of the terminal device according to the context;
generate a reject message authentication code for integrity (RejectMAC-I) according to the parameter information; and
send the RRC reject message to the terminal device, where the RRC reject message carries the RejectMAC-I.

26. The apparatus according to embodiment 25, where the parameter information includes at least one of: a key, a bear ID, a data transmission direction, a sequence number (COUNT value), a source cell radio network temporary identifier (source C-RNTI), a source physical cell identifier (source PCI), a target cell-ID, a resumeCause, and a waitTime.

27. The apparatus according to embodiment 24, where the target indication information is a RejectMAC-I, and the transceiver unit is specifically configured to:
send the RRC reject message to the terminal device, where the RRC reject message carries the RejectMAC-I.

28. The apparatus according to embodiment 25, where the processing unit is specifically configured to:
send first signaling to the second network device in response to rejecting the access of the terminal device, where the first signaling is configured to request the context of the terminal device from the second network device; and
receive second signaling sent from the second network device, where the second signaling is configured to provide the context of the terminal device.

29. The apparatus according to embodiment 28, where the first signaling is a retrieve UE context request, or, the first signaling is custom signaling transmitted through an Xn interface.

30. The apparatus according to embodiment 28, where the second signaling is a retrieve UE context response, or, the second signaling is custom signaling transmitted through an Xn interface.

31. The apparatus according to embodiment 27, where the processing unit is specifically configured to:
send third signaling to the second network device in response to rejecting the access of the terminal device, where the third signaling is configured to trigger the second network device to generate the RejectMAC-I according to the context of the terminal device; and
receive the RejectMAC-I sent from the second network device.

32. The apparatus according to any one of embodiments 24-31, where the RejectMAC-I is configured to determine validity of the RRC reject message.

33. The apparatus according to embodiment 32, where the transceiver unit is further configured to:
send first indication information to the terminal device, where the first indication information is configured to indicate to the terminal device that the RejectMAC-I is available in a random access network notification area (RNA).

34. An apparatus for transmitting a radio resource control (RRC) reject message, suitable for a second network device, and including:
a transceiver unit configured to send target indication information to a first network device in response to determining that the first network device rejects access of a terminal device, where the target indication information is configured to send the RRC reject message to the terminal device.

35. The apparatus according to embodiment 34, where the target indication information is a context of the terminal device, and the transceiver unit is specifically configured to:
receive first signaling sent from the first network device, where the first signaling is configured to request the context of the terminal device from the second network device, and the terminal device is a terminal device requesting RRC resume from the first network device; and
send second signaling to the first network device, where the second signaling is configured to provide the context of the terminal device.

36. The apparatus according to embodiment 35, where the context of the terminal device includes at least one of: a key, a bear ID, a data transmission direction, a sequence number (COUNT value), a source cell radio network temporary identifier (source C-RNTI), a source physical cell identifier (source PCI), a target cell-ID, a resumeCause, and a waitTime.

37. The apparatus according to embodiment 35, where the first signaling is a retrieve UE context request, or, the first signaling is custom signaling transmitted through an Xn interface.

38. The apparatus according to embodiment 35, where the second signaling is a retrieve UE context response, or, the second signaling is custom signaling transmitted through an Xn interface.

39. The apparatus according to embodiment 34, where the target indication information is a reject message authentication code for integrity (RejectMAC-I), and the transceiver unit is specifically configured to:
receive third signaling sent from the first network device;
extract parameter information from a context of the terminal device according to the context;
generate the RejectMAC-I according to the parameter information; and
send the RejectMAC-I to the first network device.

40. The apparatus according to embodiment 39, where the RejectMAC-I is configured to determine validity of the RRC reject message.

41. The apparatus according to any one of embodiments 34-40, where the transceiver unit is further configured to:
send second indication information to the terminal device, where the second indication information is configured to indicate to the terminal device that the RejectMAC-I is available in a random access network notification area (RNA).

42. The apparatus according to embodiment 41, where the transceiver unit is further configured to:
receive security capability indication information sent from the terminal device, where the security capability indication information is configured to indicate that the terminal device has a capability of determining the validity of the RRC reject message according to the RejectMAC-I.

43. An apparatus for transmitting a radio resource control (RRC) reject message, suitable for a terminal device, and including:
a transceiver unit configured to send an RRC resume request message to a first network device; where
the transceiver unit is further configured to receive the RRC reject message sent from the first network device, where the RRC reject message carries a reject message authentication code for integrity (RejectMAC-I).

44. The apparatus according to embodiment 43, where the RejectMAC-I is configured to determine validity of the RRC reject message.

45. The apparatus according to embodiment 43 or 44, where the transceiver unit is further configured to:
receive indication information sent from a network device, where the indication information is configured to indicate to the terminal device that the RejectMAC-I is available in a random access network notification area (RNA).

46. The apparatus according to embodiment 45, where the transceiver unit is further configured to:
send security capability indication information to a second network device, where the security capability indication information is configured to indicate that the terminal device has a capability of determining the validity of the RRC reject message according to the RejectMAC-I.

47. A communication apparatus, including a processor and a memory, where the memory stores a computer program, and the processor executes the computer program stored in the memory, so as to cause the apparatus to perform the method according to any one of embodiments 1-10 or to perform the method according to any one of embodiments 11-19.

48. A communication apparatus, including a processor and a memory, where the memory stores a computer program, and the processor executes the computer program stored in the memory, so as to cause the apparatus to perform the method according to any one of embodiments 20-23.

49. A communication apparatus, including a processor and an interface circuit, where
the interface circuit is configured to receive a code instruction and transmit the code instruction to the processor; and
the processor is configured to run the code instruction, so as to perform the method according to any one of embodiments 1-10 or the method according to any one of embodiments 11-19.

50. A communication apparatus, including a processor and an interface circuit, where
the interface circuit is configured to receive a code instruction and transmit the code instruction to the processor; and
the processor is configured to run the code instruction, so as to perform the method according to any one of embodiments 20-23.

51. A computer-readable storage medium, configured to store an instruction, where the instruction causes the method according to any one of embodiments 1-10 to be implemented or causes the method according to any one of embodiments 11-19 to be implemented when performed.

52. A computer-readable storage medium, configured to store an instruction, where the instruction causes the method according to any one of embodiments 20-23 to be implemented when performed.

1. A method for transmitting a radio resource control (RRC) reject message, performed by a first network device, and comprising:
receiving an RRC resume request message sent from a terminal device;
obtaining target indication information from a second network device in response to rejecting access of the terminal device; and
sending the RRC reject message to the terminal device according to the target indication information.

2. The method according to claim 1, wherein the target indication information is a context of the terminal device, and sending the RRC reject message to the terminal device according to the target indication information comprises:
extracting parameter information from the context of the terminal device according to the context;
generating a reject message authentication code for integrity (RejectMAC-I) according to the parameter information; and
sending the RRC reject message to the terminal device, wherein the RRC reject message carries the RejectMAC-I, wherein the parameter information comprises at least one of: a key, a bear ID, a data transmission direction, a sequence number (COUNT value), a source cell radio network temporary identifier (source C-RNTI), a source physical cell identifier (source PCI), a target cell-ID, a resumeCause, and a waitTime.

3. (canceled)

4. The method according to claim 1, wherein the target indication information is a RejectMAC-I, and sending the RRC reject message to the terminal device according to the target indication information comprises:
sending the RRC reject message to the terminal device, wherein the RRC reject message carries the RejectMAC-I.

5. The method according to claim 2, wherein obtaining the context of the terminal device from the second network device in response to rejecting the access of the terminal device comprises:
sending first signaling to the second network device in response to rejecting the access of the terminal device, wherein the first signaling is configured to request the context of the terminal device from the second network device; and
receiving second signaling sent from the second network device, wherein the second signaling is configured to provide the context of the terminal device.

6. The method according to claim 5, wherein at least one of the first signaling and the second signaling is custom signaling transmitted through an Xn interface; or
the first signaling is a retrieve UE context request; or
the second signaling is a retrieve UE context response; or
the first signaling is a retrieve UE context request and the second signaling is a retrieve UE context response.

7. (canceled)

8. The method according to claim 4, wherein obtaining the RejectMAC-I from the second network device in response to rejecting the access of the terminal device comprises:
sending third signaling to the second network device in response to rejecting the access of the terminal device, wherein the third signaling is configured to trigger the second network device to generate the RejectMAC-I according to a context of the terminal device; and
receiving the RejectMAC-I sent from the second network device, wherein the RejectMAC-I is configured to determine validity of the RRC reject message.

9. (canceled)

10. The method according to claim 8, further comprising:
sending first indication information to the terminal device, wherein the first indication information is configured to indicate to the terminal device that the RejectMAC-I is available in a random access network notification area (RNA).

11. A method for transmitting a radio resource control (RRC) reject message, performed by a second network device, and comprising:
sending target indication information to a first network device in response to determining that the first network device rejects access of a terminal device, wherein the target indication information is configured to send the RRC reject message to the terminal device.

12. The method according to claim 11, wherein the target indication information is a context of the terminal device, and sending the target indication information to a first network device in response to determining that the first network device rejects access of a terminal device comprises:
receiving first signaling sent from the first network device, wherein the first signaling is configured to request the context of the terminal device from the second network device, and the terminal device is a terminal device requesting RRC resume from the first network device; and
sending second signaling to the first network device, wherein the second signaling is configured to provide the context of the terminal device, wherein the context of the terminal device comprises at least one of: a key, a bear ID, a data transmission direction, a sequence number (COUNT value), a source cell radio network temporary identifier (source C-RNTI), a source physical cell identifier (source PCI), a target cell-ID, a resumeCause, and a waitTime.

13. (canceled)

14. The method according to claim 12, wherein at least one of the first signaling and the second signaling is custom signaling transmitted through an Xn interface; or
the first signaling is a retrieve UE context request; or
the second signaling is a retrieve UE context response; or
the first signaling is a retrieve UE context request and the second signaling is a retrieve UE context response.

15. (canceled)

16. The method according to claim 11, wherein the target indication information is a reject message authentication code for integrity (RejectMAC-I), and sending the target indication information to the first network device in response to determining that the first network device rejects access of a terminal device comprises:
receiving third signaling sent from the first network device;
extracting parameter information from a context of the terminal device according to the context;
generating the RejectMAC-I according to the parameter information; and
sending the RejectMAC-I to the first network device, wherein the RejectMAC-I is configured to determine validity of the RRC reject message.

17. (canceled)

18. The method according to claim 16, further comprising:
sending second indication information to the terminal device, wherein the second indication information is configured to indicate to the terminal device that the RejectMAC-I is available in a random access network notification area (RNA).

19. The method according to claim 18, further comprising:
receiving security capability indication information sent from the terminal device, wherein the security capability indication information is configured to indicate that the terminal device has a capability of determining the validity of the RRC reject message according to the RejectMAC-I.

20. A method for transmitting a radio resource control (RRC) reject message, performed by a terminal device, and comprising:
sending an RRC resume request message to a first network device; and
receiving an RRC reject message sent from the first network device, wherein the RRC reject message carries a reject message authentication code for integrity (RejectMAC-I).

21. The method according to claim 20, wherein the RejectMAC-I is configured to determine validity of the RRC reject message.

22. The method according to claim 20, further comprising:
receiving indication information sent from a network device, wherein the indication information is configured to indicate to the terminal device that the RejectMAC-I is available in a random access network notification area (RNA).

23. The method according to claim 22, further comprising:
sending security capability indication information to a second network device, wherein the security capability indication information is configured to indicate that the terminal device has a capability of determining validity of the RRC reject message according to the RejectMAC-I.

24.-46. (canceled)

47. A communication apparatus, comprising a processor and a memory, wherein the memory stores a computer program, and the processor executes the computer program stored in the memory, so as to cause the communication apparatus to perform the method according to claim 1.

48.-52. (canceled)

53. A communication apparatus, comprising a processor and a memory, wherein the memory stores a computer program, and the processor executes the computer program stored in the memory, so as to cause the communication apparatus to perform the method according to claim 11.

54. A communication apparatus, comprising a processor and a memory, wherein the memory stores a computer program, and the processor executes the computer program stored in the memory, so as to cause the communication apparatus to perform the method according to claim 20.
